(19) United States
(12) Patent Application Publication
(10) Pub. No.: US 2014/0173657 A1
(43) Pub. Date: Jun. 19, 2014

(54) System and Method for Auxiliary Television Programming Information

(71) Applicant: Themistokles Afentakis, Vancouver, WA (US)

(72) Inventor: Themistokles Afentakis, Vancouver, WA (US)

(21) Appl. No.: 13/713,956

(22) Filed: Dec. 13, 2012

(51) Int. Cl. H04N 21/81

(52) U.S. Cl. CPC H04N 21/8173
USPC 725/40

(57) ABSTRACT

An Auxiliary Electronic Program Guide (AEPG) television system is provided with a receiver having a network interface to accept broadcast channel information, including programs with visual content and Electronic Program Guide (EPG) information describing the programs. The receiver converts selected programs into display data supplied at a display interface. A display has an input to accept the display data and a screen to present images for the selected channels. An auxiliary module converts the EPG information into a code signal representing the EPG information. A user interface (e.g., the display screen) supplies the code signal to a remote device. For example, the auxiliary module converts the EPG information into code signal enabled as a compact code image, and the display screen presents the compact code as an image. In one aspect, the compact code image is a 2D barcode.

### BACKGROUND OF THE INVENTION

1. Field of the Invention

This invention generally relates to television displays and, more particularly, to a system for providing an Auxiliary Electronic Program Guide (AEPG), to augment an Electronic Program Guide (EPG).

2. Description of the Related Art

As noted in Wikipedia, Electronic Program Guides (EPGs) and interactive program guides (IPGs) provide users of television, radio, and other media applications with continuously updated menus displaying broadcast programming or scheduling information for current and upcoming programming. Some guides such as Fry also feature backward scrolling to promote their catch up content. Non-interactive electronic program guides (sometimes known as “navigation software”) are typically available for television and radio, and consist of a digitally displayed, non-interactive menu of broadcast programming scheduling information shown by a cable or satellite TV provider to its viewers on a dedicated channel. EPGs are broadcast by specialized video character generation (CG) equipment housed within each such provider's central television distribution facility. By tuning into an EPG channel, a menu is displayed that lists current and upcoming television programs on all available channels.

A more modern form of the EPG, associated with both television and radio broadcasting, is the IPG, often referred to as EPG. An IPG allows television viewers and radio listeners to navigate scheduling information menus interactively, selecting and discovering programming by time, title, station, or genre using an input device such as a keypad, computer keyboard, or TV remote control. Its interactive menus are generated entirely within local receiving or display equipment using raw scheduling data sent by individual broadcast stations or centralized scheduling information providers.

Data to populate an interactive EPG may be distributed over the Internet, either for a charge or free of charge, and implemented on equipment connected directly or through a computer to the Internet, Television-based IPGs in conjunction with Programme Delivery Control (PDC) technology can also facilitate the selection of programs for recording with digital video recorders (DVRs), also known as personal video recorders (PVRs).

For television, IPG support is built into almost all modern receivers for digital cable, digital satellite, and over-the-air digital broadcasting. They are also commonly featured in digital video recorders. Higher-end receivers for digital broadcast radio and digital satellite radio commonly feature built-in IPGs as well.

Demand for non-interactive TV electronic program guides television channels displaying listings for currently airing and upcoming programming has been nearly eliminated by the widespread availability of interactive program guides for television, Television-based IPGs provide the same information as EPGs, but faster and often in much more detail. When television IPGs are supported by PVRs they enable viewers to plan viewing and recording by selecting broadcasts directly from the EPG, rather than programming timers.

The aspect of an IPG most noticed by users is its graphical user interface (GUI), typically a grid or table listing channel names and program titles and times: Web and Television-based IPG interfaces allow the user to highlight any given listing and call up additional information about it supplied by the EPG provider. Programs on offer from subchannels may also be listed. Typical IPGs also allow users the option of searching by genre, as well as immediate one-touch access to, or recording of, a selected program. Reminders and parental control functions are also often included.

Listings data for IPGs integrated into today's digital terrestrial TV and radio receivers is typically sent within each station's Moving Pictures Expert Group (MPEG) transport stream, or alongside it in a special data stream. The Advanced Television Systems Committee (ATSC) standard for terrestrial digital TV, for instance, uses tables sent in each station's Program and System Information Protocol (PSIP). These tables are meant to contain program start times and titles along with additional program descriptive metadata. Current time signals are also included for on-screen display purposes, and they are also used to set timers on recording devices,

Devices embedded within modern digital cable and satellite TV receivers, on the other hand, customarily rely upon third-party listings metadata aggregators to provide them with their on-screen listings data. A growing trend is for software developers such as Microsoft inn their Windows Media Center to use an Internet connection to acquire data for their built-in IPGs. This enables greater interactivity with the IPG such as media downloads, series recording, and programming of the recordings for the IPG remotely.

Unfortunately, even the more sophisticated conventional IPG and EPG systems require the set-top box to access any enhanced programming information associated with a program. Further, the enhanced programming information is limited by the narrow range of data sources.

It would be advantageous if a means existed for a user to access auxiliary EPG information without relying upon the content source provider, the set-top box, or a IPG/EPG data source.

### SUMMARY OF THE INVENTION

Disclosed herein is an integrated system that enables the viewer of a television program to rapidly retrieve and share broadcast information as it is being watched. This capability is enabled by some of the following components: a television set with enhanced software and hardware, and a software program running on a portable device equipped with a wireless network connection, and a camera or other sensor. The system enables the user to seamlessly access a much broader information base, on demand. The system works in the following sequence. The television encodes information concerning a broadcast in a proprietary or open-source digital form. The user employs a device, such as a laptop personal computer (PC), a cell phone, or personal digital assistant (FDA), etc., which runs a program that can decode the encoded channel information, supplied by the television. A related program on the user's portable device can seamlessly and directly access a database for additional information using the Internet. Some example of databases that might be accessed include Wikipedia and Google, movie rating databases such as imdb and Rotten Tomatoes, and social networking sites, etc. Thus, the user has access to a wealth of information, with a push of a button.

The television has the ability to decode the channel information as received from the station, and encode it in a digital form that can be read from a properly-equipped portable device. For example, the television set can encode this information in the form of a two-dimensional matrix barcode, such as a Quick Response (QR) code, and display it on screen. A portable device is equipped with a camera (or other suitable sensor) and, ideally, Internet connectivity. The user activates the code-reading software of the portable device, which reads and decodes the television barcode, and seamlessly activates a number of Internet connections.

Accordingly, an Auxiliary Electronic Program Guide (AEPG) television system is provided with a receiver having a network interface to accept broadcast channel information, including programs with visual content and Electronic Program Guide (EPG) information describing the programs. The receiver converts selected programs into display data supplied at a display interface. A display has an input to accept the display data and a screen to present images for the selected channels. An auxiliary module converts the EPG information into a code signal representing the EPG information. A user interface (e.g., the display screen) supplies the code signal to a remote device. For example, the auxiliary module converts the EPG information into code signal enabled as a compact code image, and the display screen presents the compact code as an image. In one aspect, the compact code image is a two-dimensional barcode.

In another aspect, a remote device enabled as a portable computer, has a camera for capturing the compact code image presented on the display screen, and a network interface such as cellular telephone, Ethernet. Bluetooth or IEEE 802.3 WiFi. In one aspect, a wireless television interface accepts an initiation signal from the remote device, and supplies a trigger signal to the auxiliary module. Then, the auxiliary module converts the EPG information into a code signal representing the EPG information in response to the trigger signal.

Additional details of the above-described system, and an Auxiliary Electronic Program Guide (AEPG) software application, are provided below.

### BRIEF DESCRIPTION OF THE DRAWINGS

FIG. 1 is a schematic block diagram of an Auxiliary Electronic Program Guide (AEPG) television system.

FIG. 2 is a schematic block diagram depicting a portable electronic device with a system for deriving AEPG information from a photographed compact code image.

FIG. 3 is a block diagram depicting an AEPG software application, stored in a non-transitory memory of a computing device, and executed as a sequence of microprocessor instruction.

FIG. 4 depicts some examples of 2D barcodes.

FIG. 5 pictorially represents a process for accessing AEPG.

FIG. 6 is a diagram depicting a television screen displaying a 2D barcode.

### DETAILED DESCRIPTION

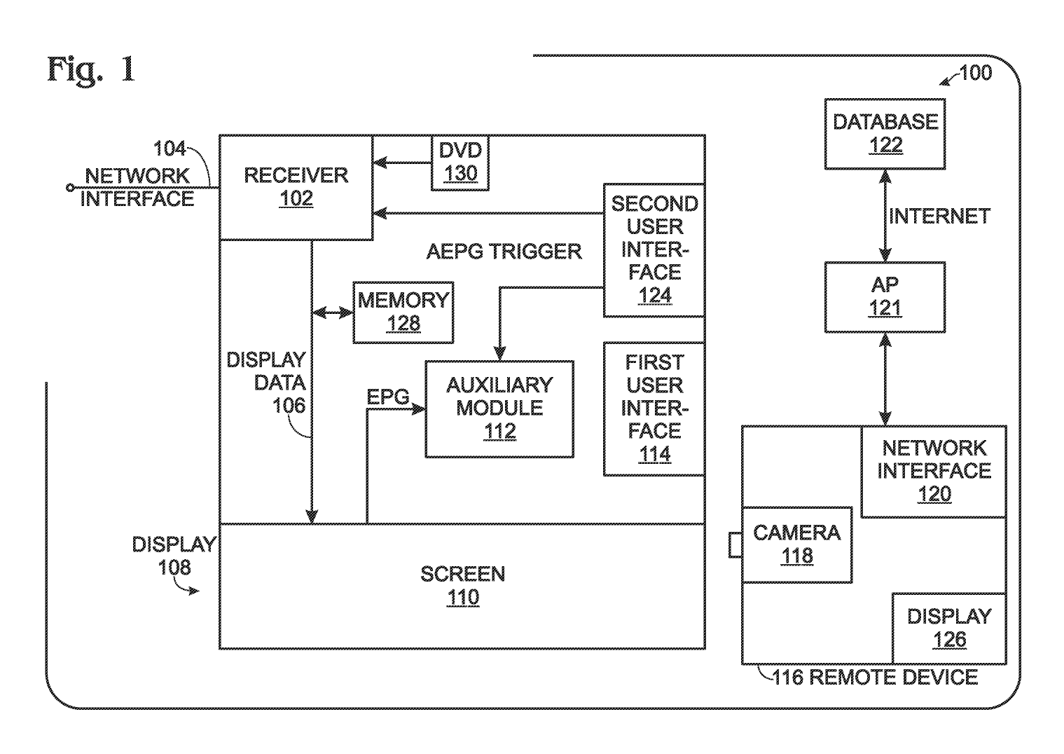

FIG. 1 is a schematic block diagram of an Auxiliary Electronic Program Guide (AEPG) television system. The system 100 comprises a receiver 102 having a network interface on line 104 to accept broadcast channel information, including programs with visual content and Electronic Program Guide (EPG) information describing the programs. As used herein, EPG information also includes Interactive Program Guide (IPG) information. For example, the network interface on line 104 may be a cable, satellite, or over-the-air content provider. Typically, the receiver 102 accepts EPG information for previously presented, currently presented, and yet to be presented programs. The receiver 102 converts selected programs into display data supplied at a display interface on line 106. A display 108 has an input on line 106 to accept the display data and a screen 110 to present images for the selected channels. The above-mentioned components are part of a conventional television, or television/set-top box combination.

An auxiliary module 112 converts the EPG information into a code signal representing the EPG information. Here, the EPG information is shown being supplied by the display 108, but alternately (not shown), it may be supplied by the receiver. A first user interface 114 supplies the code signal to a remote device 116. In one aspect, the auxiliary module 112 converts the EPG information into code signal enabled as a compact code image, and the first user interface is the display screen 110, which presents the compact code as an image. For example, the display screen 110 may present the compact code image enabled as a barcode. More explicitly, the compact code image may be a two-dimensional barcode, in one aspect, the code signal represents a commercial coupon for a product advertised on the selected program.

FIG. 6 is a diagram depicting a television screen displaying a 2D barcode.

Alternatively, the first user interface 114 may be a cellular telephone, Bluetooth, IEEE 802.3 WiFi, a proprietary wireless, or infrared signal interface.

In one aspect, the remote device 116 is enabled as a portable computer having a camera 118 for capturing the compact code image presented on the display screen 110, and a network interface 120, such as cellular telephone, Ethernet, Bluetooth, or IEEE 802.3 WiFi. Here, the network interface 120 is shown as a WiFi interface wirelessly connecting to an Access Point (AP) 121, to provide Internet connectivity of a database 122. The remote device may be a cellular phone, laptop computer, personal digital assistant (PDA), or special enabled television remote control. Additional details of the remote device 116 are provided below.

In another aspect, the television system 100 further comprises a second user interface 124 to accept an initiation signal from the remote device 116, and to supply a trigger signal to the auxiliary module 112. Then, the auxiliary module 112 converts the EPG information into a code signal representing the EPG information in response to the trigger signal. In the event that the first interface 114 is a cellular telephone, IEEE 802.3 WiFi, Bluetooth, a proprietary wireless, or infrared signal interface, the first and second interfaces may be the same interface.

In one aspect, the second user interface 124 accepts an information package from the remote device containing Auxiliary EPG (AEPG) information concerning the selected program, in response to the sending the code signal to the remote device. The receiver 102, or some other module capable of image data generation, accepts the information package and supplies the digital data representing the information package to the display interface on line 106. The display screen 110 presents the information package digital data. Alternatively, the AEPG information is viewed on a remote device display screen 126.

In another aspect, the television system 100 further comprises a memory 128, which enables the receiver 102 to store a currently selected program in memory 128, and pause the supply of display data while the information package digital data is presented on the display screen 110.

In another aspect, the television system 100 further comprises a digital video disk (DVD) device 130 having an output connected to the receiver 102 to supply programs with visual content and information describing the DVD programs. The auxiliary module 112 converts the information describing the DVD programs into a code signal, and the first user interface 114 supplies the code signal to the remote device 116.

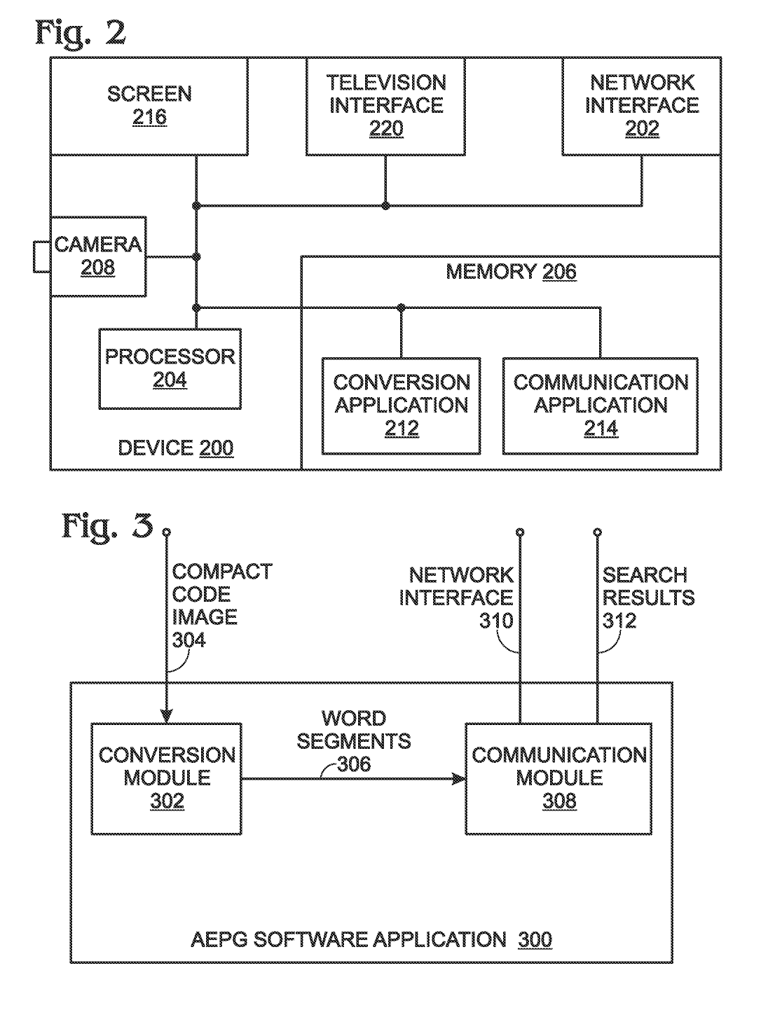

FIG. 2 is a schematic block diagram depicting a portable electronic device with a system for deriving AEPG information from a photographed compact code image. The system 200 comprises a network /interface 202, a processor 204, and a non-transitory memory 206. The network interface 202 may be a cellular telephone, Ethernet, Bluetooth, and IEEE 802.3 WiFi.

A camera 208 with an optical interface captures a photographed compact code image representation of Electronic Program Guide (EPG) information. The camera 208 has an electronic interface to supply a digital information representation of the compact code image. A conversion application 212 is stored in memory 206 as a sequence of processor executable steps for converting the digital information representation of the compact code image into word segments. A communication application 214 is stored memory 206 as a sequence of processor executable steps for executing searches for AEPG information based upon the word segments via the network interface, and retrieving AEPG search results.

Typically, the system 200 further comprises a screen 216 having an interface connected to the communication application to display the search results. In one aspect, the camera optical interface accepts the compact code image enabled as a barcode, for example, a two-dimensional barcode.

In another aspect, the system 200 further comprises a television interface 220 for sending an initiation signal to a television, to trigger the supply of the compact code image. The television interface 220 may be a cellular telephone, IEEE 802.3 WiFi, Bluetooth, a proprietary wireless, or infrared signal interface. Further, the television interface 220 may accept an information package from the communication application 214 containing the AEPG search results, and send the information package to a television. As part of this process, the television interface 220 may send a program pause signal to the television, to pause a currently selected program while the information package data is presented on a television display screen.

FIG. 3 is a block diagram depicting an AEPG software application, stored in a non-transitory memory of a computing device, and executed as a sequence of microprocessor instruction. The AEPG application 300 comprises a conversion module 302 for accepting a compact code image representing EPG information on line 304, and converting the EPO information into word segments supplied on line 306. A communication module 308 executes AEPG information searches based upon the word segments via a network interface on line 310, retrieves the search results, and present the search results on line 312 to a computing device user interface.

Channel and content information is received by a television set as a standard part of the digital broadcast from the airwaves, or the cable/satellite provider. The television system described herein is equipped with firmware that encodes the information into a two-dimensional (2D) barcode, for example, and displays the code on the TV screen. In another implementation, the television transmits this encoded information via a dedicated wireless or optical link to a remote device.

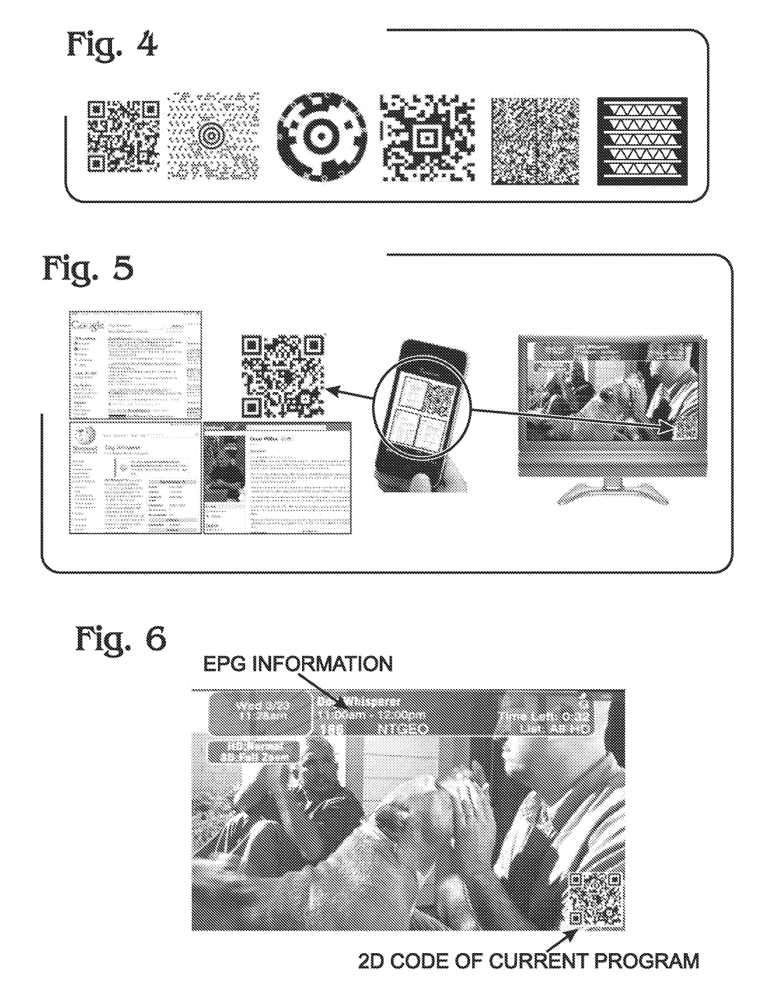

FIG. 4 depicts some examples of 2D barcodes. From left to right the 2D barcodes are: QR code, MaxiCode. ShotCode. Aztec code, Data Matrix 2D code, and High Capacity Color Barcode (without colors) Unlike one-dimensional barcode that are designed to be mechanically scanned by a narrow beam of light, a QR code, for example, is detected as a 2D digital image that is digitally analyzed by a programmed processor. The processor locates the three distinctive squares at the corners of the image and uses a smaller square near the fourth corner to normalize the image for size, orientation, and angle of viewing. The small dots are then converted to binary numbers and validity checked with an error-correcting code.

FIG. 5 pictorially represents a process for accessing AEPG. In Step 1, a camera-equipped portable device photographs a 2D barcode. In Step 2, the device runs proprietary software that decodes the 2D barcode, connects to the Internet to retrieve additional information from default or user-selected web pages, and displays the results.

2D barcode reading applets (for example, for the QR code) are commercially available for a number of portable platforms. The system described herein is not restricted to a specific type of code. Rather, the system is the synergy between the TV generated and displayed code, and the portable device software application able to make searches based upon the code.

This system is not necessarily limited to nominally selected television programs. For example, if commercial content is encoded, the system can search for retailers of products that may be advertised during the program. Further, the system may be used access online coupons and discounts, etc.

Systems have been provided for accessing AEPG. Examples of particular process steps and hardware units have been presented to illustrate the invention. However, the invention is not limited to merely these examples. Other variations and embodiments of the invention will occur to those skilled in the art.

We claim:

1. An Auxiliary Electronic Program Guide (AEPG) television system, the system comprising:
a receiver having a network interface to accept broadcast channel information, including programs with visual content and Electronic Program Guide (EPG) information describing the programs, the receiver converting selected programs into display data supplied at a display interface;
a display having an input to accept the display data and a screen to present images for the selected channels;
an auxiliary module for converting the EPG information into a code signal representing the EPG information;
a first user interface to supply the code signal to a remote device;
a second user interface to accept an initiation signal sent directly from the remote device, and to supply a trigger signal to the auxiliary module; and,
wherein the auxiliary module converts the EPG information into a code signal representing the EPG information in response to the trigger

2. The television system of claim wherein the auxiliary module converts the EPG information into code signal enabled as a compact code image; and,
wherein the first user interface supplying the code signal is the display screen presenting the compact code as an image.

3. The television system of claim 2 wherein the display screen presents the compact code image enabled as a two-dimensional barcode.

4. The television system of claim 2 further comprising:
a remote device enabled as a portable computer having a camera for capturing the compact code image presented on the display screen, and a network interface selected from a group consisting of cellular telephone, Ethernet, Bluetooth, and IEEE 802.11 WiFi.

5. The television system of claim 1 wherein first user interface supplies the code signal representing a commercial coupon for a product advertised on the selected program,

6. The television system of claim 1 wherein the receiver accepts EPG information for programs selected from a group consisting of previously presented, currently presented, and yet to be presented programs.

7. The television system of claim 1 wherein the first user interface is selected from a group consisting of a cellular telephone, Bluetooth, IEEE 802.11 WiFi, a proprietary wireless, and infrared signal interface.

8. (canceled)

9. The television system of claim 1 wherein the second user interface is selected from a group consisting of a cellular telephone, IEEE 802.11 WiFi, Bluetooth, a proprietary wireless, and infrared signal interface.

10. The television system of claim 1 wherein the second user interface accepts an information package from the remote device containing Auxiliary EPG (AEPG) information concerning the selected program, in response to sending the code signal to the remote device;
wherein the receiver accepts the e information package and supplies the digital data representing the information package to the display interface; and,
wherein the display screen presents the information package digital data.

11. The television system of claim 10 further comprising:
a memory;
wherein the receiver stores the selected program in memory and pauses the supply of display data while the information package digital data is presented on the display screen.

12. The television system of claim 1 further comprising:
a digital video disk (DVD) device having an output connected to the receiver to supply programs with visual content and information describing the DVD programs;
wherein the auxiliary module converts the information describing the DVD programs into a code signal; and,
wherein the first user interface supplies the code signal to the remote device.

13. In a portable electronic device, a system for deriving Auxiliary Electronic Program Guide (AEPG) information from a photographed compact code image, the system comprising:
a network interface;
a processor;
a non-transitory memory;
a camera with an optical interface to capture a photographed compact code image representation of Electronic Program Guide (EPG) information, and an electronic interface to supply a digital information representation of the compact code image;
a conversion application stored in non-transitory memory as a sequence of processor executable steps for converting the digital information representation of the compact code image into word segments;
a communication application stored in non-transitory memory as a sequence of processor executable steps for executing searches via the network interface for AEPG information based upon the word segments, and to retrieve AEPG search results; and
a television interface for directly sending an initiation signal to a television, to trigger the supply of the compact code image.

14. The system of claim 13 further comprising:
a screen having an interface connected to the communication application to display the search results.

15. The system of claim 13 wherein the network interface is a wireless network interface selected from a group consisting of cellular telephone, Ethernet, Bluetooth, and IEEE 802.11 WiFi.

16. The system of claim 13 wherein the camera optical interface accepts the compact code image enabled as a two-dimensional barcode.

17. (canceled)

18. The system of claim 13 wherein the television interface is selected from a group consisting of a cellular telephone, IEEE 802.11 WiFi, Bluetooth, a proprietary wireless, and infrared signal interface.

19. The system of claim 13 wherein the television interface accepts an information package from the communication application containing the AEPG search results, and sends the information package to a television.

20. The system of claim 19 wherein the television interface sends a program pause signal to the television, to pause a program while information package data is presented on a television display screen.

21. A non-transitory computer-readable storage medium comprising computer executable instructions, which when executed by a processor of a computer device, cause the computing device to:
accept a compact code image representing Electronic Program Guide (EPG) information, and convert the EPG information into word segments; and,
execute AEPG information searches based upon the word segments via a network interface, retrieve search results, and present the search results to a computing device user interface.

22. An Auxiliary Electronic Program Guide (AEPG) television system, the system comprising:
a receiver having a network interface to accept broadcast channel information, including programs with visual content and Electronic Program Guide (EPG) information describing the programs, the receiver converting selected programs into display data supplied at a display interface;
a display having an input to accept the display data and a screen to present images for the selected channels;
an auxiliary module for converting the EPG information into a code signal representing the EPG information; and,
a first user interface to supply the code signal to a remote device, wherein the first user interface is selected from a group consisting of a cellular telephone, Bluetooth, IEEE 802.11 WiFi, a proprietary wireless, and infrared signal interface.
